(19) United States
(12) Patent Application Publication
(10) Pub. No.: US 2015/0039760 A1
(43) Pub. Date: Feb. 5, 2015

(54) REMOTELY CONTROLLING WEB REAL-TIME COMMUNICATIONS (WEBRTC) CLIENT FUNCTIONALITY VIA WEBRTC DATA CHANNELS, AND RELATED METHODS, SYSTEMS, AND COMPUTER-READABLE MEDIA

(71) Applicant: Avaya Inc., Basking Ridge, NJ (US)

(72) Inventor: John H. Yoakum, Cary, NC (US)

(73) Assignee: Avaya Inc., Basking Ridge, NJ (US)

(21) Appl. No.: 13/955,711

(22) Filed: Jul. 31, 2013

(51) Int. Cl. H04L 29/06

(52) U.S. Cl. CPC H04L 65/1059
USPC 709/225

(57) ABSTRACT

Remotely controlling Web Real-Time Communications (WebRTC) client functionality via WebRTC data channels, and related methods, systems, and computer-readable media are disclosed. In this regard, in one embodiment, a method for remotely controlling WebRTC client functionality comprises establishing, by a first WebRTC client executing on a first computing device and a second WebRTC client executing on a second computing device, a WebRTC media channel between the first WebRTC client and the second WebRTC client. The method further comprises establishing, between the first WebRTC client and the second WebRTC client, a WebRTC data channel affiliated with the WebRTC media channel. The method also comprises receiving, by the second WebRTC client, a client control signal originating from the first WebRTC client via the WebRTC data channel. The method additionally comprises, responsive to receiving the client control signal via the WebRTC data channel, modifying a functionality associated with the second WebRTC client.

### BACKGROUND

1. Field of the Disclosure

The technology of the disclosure relates generally to Web Real-Time Communications (WebRTC) interactive sessions.

2. Technical Background

Web Real-Time Communications (WebRTC) is an ongoing effort to develop industry standards for integrating real-time communications functionality into web clients, such as web browsers, to enable direct interaction with other web clients. This real-time communications functionality is accessible by web developers via standard markup tags, such as those provided by version 5 of the Hypertext Markup Language (HTML5), and client-side scripting Application Programming Interfaces (APIs) such as JavaScript APIs. More information regarding WebRTC may be found in “WebRTC: APIs and RTCWEB Protocols of the HTML5 Real-Time Web,” by Alan B. Johnston and Daniel C. Burnett, 2^{nd} Edition (2013 Digital Codex LLC), which is incorporated in its entirety herein by reference.

WebRTC provides built-in capabilities for establishing real-time video, audio, and/or data streams in both point-to-point interactive sessions and multi-party interactive sessions. The WebRTC standards are currently under joint development by the World Wide Web Consortium (W3C) and the Internet Engineering Task Force (IETF). Information on the current state of WebRTC standards can be found at, e.g., http://www.w3c.org and http://www/ietf.org.

To establish a WebRTC interactive flow (e.g., a real-time video, audio, and/or data exchange), two WebRTC clients may retrieve WebRTC-enabled web applications, such as HTML5/JavaScript web applications, from a web application server. Through the web applications, the two WebRTC clients then engage in a media negotiation to communicate and reach an agreement on parameters that define characteristics of the interactive session. In some embodiments, the media negotiation may be implemented via a WebRTC offer/answer exchange. A WebRTC offer/answer exchange typically occurs via a secure network connection such as a Hyper Text Transfer Protocol Secure (HTTPS) connection or a Secure WebSockets connection. In a WebRTC offer/answer exchange, a first WebRTC client on a sender computing device sends an “offer” to a second WebRTC client on a recipient computing device. The offer includes a WebRTC session description object that specifies media types and capabilities that the first WebRTC client supports and prefers for use in the WebRTC interactive flow. The second WebRTC client then responds with a WebRTC session description object “answer” that indicates which of the offered media types and capabilities are supported and acceptable by the second WebRTC client for the WebRTC interactive flow.

Once the media negotiation is complete, the WebRTC clients may then establish a direct peer connection with one another, and may begin an exchange of media or data packets transporting real-time communications. The peer connection between the WebRTC clients typically employs the Secure Real-time Transport Protocol (SRTP) to transport real-time media channels, and may utilize various other protocols for real-time data interchange.

Typically, a WebRTC client provides capability for modifying various aspects of the WebRTC client functionality at a local endpoint. For example, to facilitate a WebRTC interactive media flow, the WebRTC client may allow modification of attributes of local communicatively coupled devices such as speakers, microphones, video cameras, and video displays, as non-limiting examples. However, WebRTC does not include a mechanism for a first WebRTC client to effect changes to the functionality associated with a remote WebRTC client engaged in a media exchange with the first WebRTC client.

### SUMMARY OF THE DETAILED DESCRIPTION

Embodiments disclosed in the detailed description provide remotely controlling Web Real-Time Communications (WebRTC) client functionality via WebRTC data channels. Related methods, systems, and computer-readable media are also disclosed. In this regard, in one embodiment, a method for remotely controlling WebRTC client functionality is provided. The method comprises establishing, by a first WebRTC client executing on a first computing device and a second WebRTC client executing on a second computing device, a WebRTC media channel between the first WebRTC client and the second WebRTC client. The method further comprises establishing, between the first WebRTC client and the second WebRTC client, a WebRTC data channel affiliated with the WebRTC media channel. The method additionally comprises receiving, by the second WebRTC client, a client control signal originating from the first WebRTC client via the WebRTC data channel. The method also comprises, responsive to receiving the client control signal via the WebRTC data channel, modifying a functionality associated with the second WebRTC client.

In another embodiment, a system for remotely controlling WebRTC client functionality is provided. The system comprises at least one communications interface, and first and second computing devices associated with the at least one communications interface. The first computing device comprises a first WebRTC client comprising a WebRTC client control agent. The second computing device comprises a second WebRTC client comprising a WebRTC functionality modification agent. The first WebRTC client and the second WebRTC client are configured to establish a WebRTC media channel between the first WebRTC client and the second WebRTC client. The WebRTC client control agent and the WebRTC functionality modification agent are configured to establish a WebRTC data channel affiliated with the WebRTC media channel. The WebRTC functionality modification agent is further configured to receive a client control signal originating from the WebRTC client control agent via the WebRTC data channel. The WebRTC functionality modification agent is additionally configured to, responsive to receiving the client control signal via the WebRTC data channel, modify a functionality associated with the second WebRTC client.

In another embodiment, a non-transitory computer-readable medium is provided. The non-transitory computer-readable medium has stored thereon computer-executable instructions to cause a processor to implement a method comprising establishing a WebRTC media channel between a first WebRTC client and a second WebRTC client. The method implemented by the computer-executable instructions further comprises establishing, between the first WebRTC client and the second WebRTC client, a WebRTC data channel affiliated with the WebRTC media channel. The method implemented by the computer-executable instructions additionally comprises receiving, by the second WebRTC client, a client control signal originating from the first WebRTC client via the WebRTC data channel. The method implemented by the computer-executable instructions also comprises, responsive to receiving the client control signal via the WebRTC data channel, modifying a functionality associated with the second WebRTC client.

### BRIEF DESCRIPTION OF THE FIGURES

The accompanying drawing figures incorporated in and forming a part of this specification illustrate several aspects of the disclosure, and together with the description serve to explain the principles of the disclosure:

FIG. 1 is a conceptual diagram illustrating an exemplary topology of a Web Real-Time Communications (WebRTC) interactive session between a first WebRTC client including a WebRTC client control agent, and a second WebRTC client including a WebRTC functionality modification agent;

FIG. 2 is a flowchart illustrating exemplary operations for remotely controlling WebRTC client functionality via a WebRTC data channel;

FIG. 3 is a diagram illustrating exemplary communications flows within an exemplary system including the WebRTC client control agent and the WebRTC functionality modification agent of FIG. 1;

FIGS. 4A and 4B are flowcharts illustrating more detailed exemplary operations for remotely controlling WebRTC client functionality via a corresponding WebRTC data channel; and

FIG. 5 is a block diagram of an exemplary processor-based system that may include the WebRTC client control agent and the WebRTC functionality modification agent of FIG. 1.

### DETAILED DESCRIPTION

With reference now to the drawing figures, several exemplary embodiments of the present disclosure are described. The word “exemplary” is used herein to mean “serving as an example, instance, or illustration.” Any embodiment described herein as “exemplary” is not necessarily to be construed as preferred or advantageous over other embodiments.

Embodiments disclosed in the detailed description provide remotely controlling Web Real-Time Communications (WebRTC) client functionality via WebRTC data channels. Related methods, systems, and computer-readable media are also disclosed. In this regard, in one embodiment, a method for remotely controlling WebRTC client functionality is provided. The method comprises establishing, by a first WebRTC client executing on a first computing device and a second WebRTC client executing on a second computing device, a WebRTC media channel between the first WebRTC client and the second WebRTC client. The method further comprises establishing, between the first WebRTC client and the second WebRTC client, a WebRTC data channel affiliated with the WebRTC media channel. The method additionally comprises receiving, by the second WebRTC client, a client control signal originating from the first WebRTC client via the WebRTC data channel. The method also comprises, responsive to receiving the client control signal via the WebRTC data channel, modifying a functionality associated with the second WebRTC client.

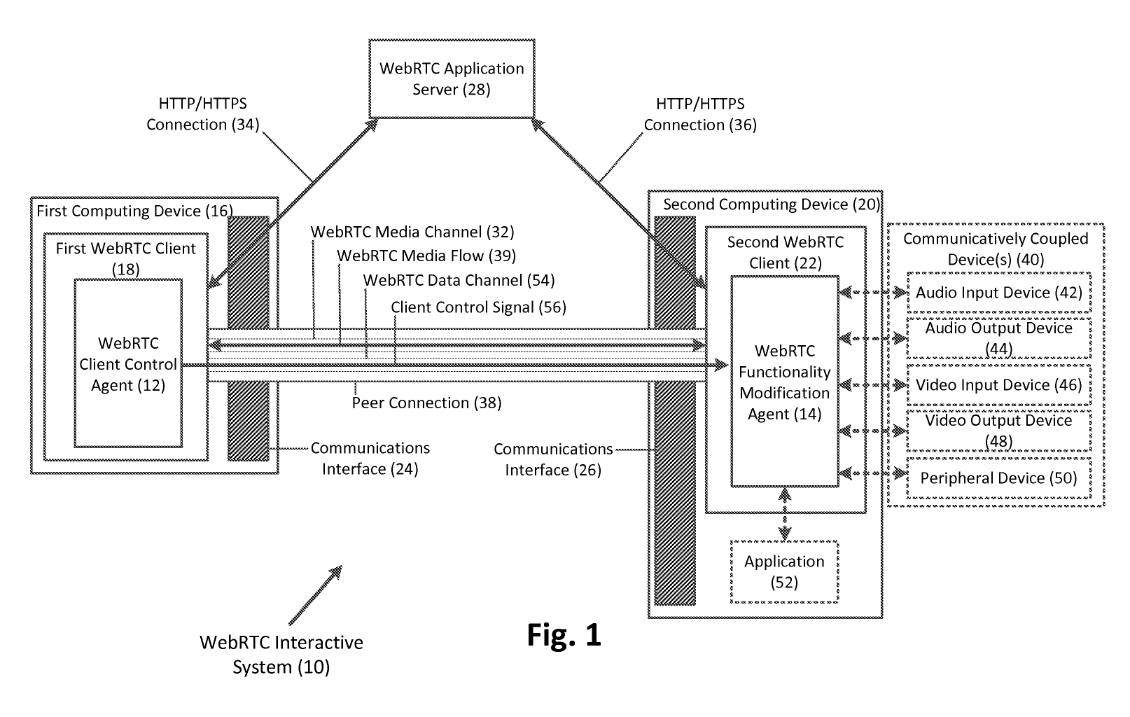

In this regard, FIG. 1 shows an exemplary WebRTC interactive system 10 for remotely controlling WebRTC client functionality as disclosed herein. In particular, the exemplary WebRTC interactive system 10 includes a WebRTC client control agent 12 that provides a point for issuing client control signals for indicating a desired modification to a functionality associated with a remote WebRTC client. Additionally, the exemplary WebRTC interactive system 10 includes a WebRTC functionality modification agent 14 that is communicatively coupled to the WebRTC client control agent 12, and that carries out the functionality modification requested by the WebRTC client control agent 12.

As used herein, a “WebRTC media channel” refers to a connection between two WebRTC clients for securely exchanging video and/or audio or other real-time media, while a “WebRTC data channel” refers to a connection between two WebRTC clients for exchanging data in one or more arbitrary formats. It is to be understood that a WebRTC media channel and a WebRTC data channel may be multiplexed over a single peer connection between the WebRTC clients and/or may be associated with the same User Datagram Protocol (UDP) port of the WebRTC clients. A “WebRTC media flow,” as referenced herein, refers to video and/or audio data packets passing over a WebRTC media channel. As non-limiting examples, a WebRTC media flow may include a real-time audio stream and/or a real-time video stream, or other real-time media or data streams.

Before discussing details of the WebRTC client control agent 12 and the WebRTC functionality modification agent 14, the establishment of a WebRTC interactive flow in the WebRTC interactive system 10 of FIG. 1 is first described. In FIG. 1, a first computing device 16 executes a first WebRTC client 18, and a second computing device 20 executes a second WebRTC client 22. It is to be understood that the computing devices 16 and 20 may both be located within a same public or private network, or may be located within separate, communicatively coupled public or private networks. Some embodiments of the WebRTC interactive system 10 of FIG. 1 may provide that each of the first and second computing devices 16, 20 may be any computing device having network communications capabilities, such as a smartphone, a tablet computer, a dedicated web appliance, a media server, a desktop or server computer, or a purpose-built communications device, as non-limiting examples. The first and second computing devices 16, 20 include communications interfaces 24 and 26 respectively, for connecting the first and second computing devices 16, 20 to one or more public and/or private networks. In some embodiments, the elements of the first and second computing devices 16, 20 may be distributed across more than one computing device 16, 20.

The first and second WebRTC clients 18, 22, in this example, may each be a web browser application, a dedicated communications application, or an interface-less application such as a daemon or service application, as non-limiting examples. The first and second WebRTC clients 18, 22 each enable client-side applications written in a scripting language, such as JavaScript, to be executed. The first and second WebRTC clients 18, 22 also each provide application programming interfaces (APIs) to facilitate communications with other functionality within the first and/or second WebRTC clients 18, 22, the first and/or second computing devices 16, 20, and/or with other web clients, user devices, or web servers. In this manner, the first and second WebRTC clients 18, 22 implement the protocols, codecs, and APIs necessary to enable real-time WebRTC media and data channels.

A WebRTC application server 28 is provided for serving a WebRTC-enabled web application (not shown) to the requesting first and second WebRTC clients 18, 22. In some embodiments, the WebRTC application server 28 may be a single server, while in some applications the WebRTC application server 28 may comprise multiple servers that are communicatively coupled to each other. It is to be understood that the WebRTC application server 28 may reside within the same public or private network as the first and/or second computing devices 16, 20, or may be located within a separate, communicatively coupled public or private network.

FIG. 1 further illustrates the characteristic WebRTC “triangle” topology that results from establishing a WebRTC media channel 32 between the first WebRTC client 18 and the second WebRTC client 22. To establish the WebRTC media channel 32, the first WebRTC client 18 and the second WebRTC client 22 both download a same WebRTC web application (not shown) from the WebRTC application server 28. In some embodiments, the WebRTC web application comprises an HTML5/JavaScript web application that provides a rich user interface using HTML5, and uses JavaScript to handle user input and to communicate with the WebRTC application server 28.

The first WebRTC client 18 and the second WebRTC client 22 then establish Hyper Text Transfer Protocol (HTTP)/Hyper Text Transfer Protocol Secure (HTTPS) connections 34 and 36, respectively, with the WebRTC application server 28, and engage in a media negotiation such as a WebRTC offer/answer exchange, as a non-limiting example. Once the media negotiation is complete, the WebRTC media channel 32 may be established via a peer connection 38 between the first WebRTC client 18 and the second WebRTC client 22, and a WebRTC media flow 39 may commence. Accordingly, in FIG. 1, the vertices of the WebRTC “triangle” are the WebRTC application server 28, the first WebRTC client 18, and the second WebRTC client 22. The edges of the “triangle” are represented by the secure web connections 34, 36 and the peer connection 38. It is to be understood that some embodiments may utilize topographies other than the WebRTC “triangle” topography illustrated in FIG. 1. For example, some embodiments may employ a “trapezoid” topography in which two web application servers communicate directly with each other via protocols such as Session Initiation Protocol (SIP) or Jingle, as non-limiting examples.

In some scenarios, situations may arise where it may be useful or beneficial to enable a user (not shown) of the first WebRTC client 18 to remotely control functionality associated with the second WebRTC client 22. It is to be understood that as used herein, “remotely controlling WebRTC client functionality” may include modifying an attribute associated with one or more communicatively coupled devices 40 communicatively coupled to the WebRTC functionality modification agent 14. The communicatively coupled device(s) 40 may include an audio input device 42 such as a microphone; an audio output device 44 such as a speaker; a video input device 46 such as a video camera, webcam, or still camera; a video output device 48 such as a video display, and/or another peripheral device 50 such as a building automation device or a voice synthesizer, as non-limiting examples. The communicatively coupled device(s) 40 may be integrated into the second computing device 20 and/or the second WebRTC client 22, and/or may be separate peripheral devices connected to the second computing device 20 and/or the second WebRTC client 22. Modifying the attribute associated with the communicatively coupled device(s) 40 may include adjusting a speaker volume, a speaker muting, a microphone volume, a microphone muting, a microphone directionality, a microphone sensitivity, an audio equalization profile, a camera directionality, a camera focus, a camera zoom, a camera sensitivity, a camera aperture, a camera F-stop, a display resolution, a display brightness, or a display color profile, as non-limiting examples. Some embodiments may provide that remotely controlling WebRTC client functionality may comprise instructing the second WebRTC client 22 to initiate execution or modify execution of an application 52 on the second computing device 20.

Remote control of WebRTC client functionality may prove useful in a variety of scenarios. For instance, the WebRTC media flow 39 may represent an emergency call placed by a victim (not shown) using the second WebRTC client 22 to a first responder (not shown) using the first WebRTC client 18. If the victim is or becomes incapacitated, the first responder may need to remotely control functionality associated with the second WebRTC client 22 by, for example, redirecting a camera or increasing a microphone volume in order to assess the situation and/or to render aid. In another scenario, the first WebRTC client 18 may be used by a conference moderator (not shown) who requires the ability to remotely control the audio and video functionality associated with multiple WebRTC clients 22 used by remote conference participants.

In this regard, the WebRTC client control agent 12 and the WebRTC functionality modification agent 14 are provided to enable remote control of the second WebRTC client 22 functionality by the first WebRTC client 18. The WebRTC client control agent 12 of the first WebRTC client 18 is configured to establish a WebRTC data channel 54 with the WebRTC functionality modification agent 14 of the second WebRTC client 22. To maintain a level of security, the WebRTC data channel 54 is “affiliated” with the WebRTC media channel 32. In some embodiments, an affiliated WebRTC data channel 54 is established using the same peer connection 38 that was used to establish the WebRTC media channel 32. Some embodiments may provide that an affiliated WebRTC data channel 54 is established using a same cryptographic keying material (such as a public/private key pair or predefined key exchange technique) as was used to establish the WebRTC media channel 32.

Once the WebRTC data channel 54 is established, the WebRTC client control agent 12 may send a client control signal 56 to be received by the WebRTC functionality modification agent 14 via the WebRTC data channel 54. The client control signal 56 may be any arbitrarily formatted communication sent over the WebRTC data channel 54 instructing the WebRTC functionality modification agent 14 to modify a functionality associated with the second WebRTC client 22 (such as modifying an attribute associated with the communicatively coupled device(s) 40 or by initiating or modifying execution of an application 52 on the second computing device 20, as non-limiting examples). Upon receiving the client control signal 56, the WebRTC functionality modification agent 14 may take action to effectuate the requested functionality modification. As non-limiting examples, this may include instructing the second WebRTC client 22 to modify an attribute associated with one or more of the communicatively coupled device(s) 40 based on the client control signal 56, and/or instructing the second WebRTC client 22 to initiate or modify execution of an application 52 on the second computing device 20 based on the client control signal 56.

In some embodiments, the WebRTC client control agent 12 may receive an authorization (not shown) from the second WebRTC client 22 to modify the functionality associated with the second WebRTC client 22. For example, the authorization may specify which attributes of certain communicatively coupled device(s) 40 that the WebRTC client control agent 12 is permitted to modify, and/or may set limits on which users of the first WebRTC client 18 have permission to remotely control the functionality associated with the second WebRTC client 22. Requiring the WebRTC client control agent 12 to receive the authorization to modify functionality associated with the second WebRTC client 22 may ensure that a user (not shown) of the second WebRTC client 22 consents to remote control of the functionality associated with the second WebRTC client 22. It is to be understood that the authorization may be received prior to or following the client control signal 56, and may authorize one or more corresponding client control signals 56.

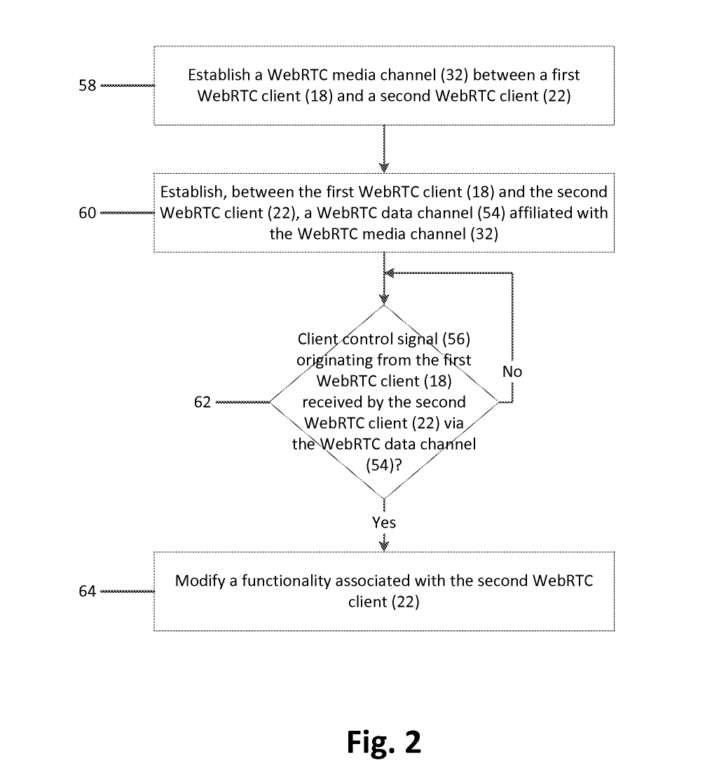

To generally describe exemplary operations for remotely controlling WebRTC client functionality, FIG. 2 is provided. For the sake of clarity, FIG. 2 refers to elements of the exemplary WebRTC interactive system 10 of FIG. 1. FIG. 2 is a flowchart illustrating exemplary operations for the WebRTC client control agent 12 and the WebRTC functionality modification agent 14 of FIG. 1. In this example of FIG. 2, operations begin with the first WebRTC client 18 and the second WebRTC client 22 establishing a WebRTC media channel 32 (block 58). The first WebRTC client 18 and the second WebRTC client 22 next establish a WebRTC data channel 54 affiliated with the WebRTC media channel 32 (block 60). In some embodiments, the WebRTC data channel 54 is established between the WebRTC client control agent 12 of the first WebRTC client 18 and the WebRTC functionality modification agent 14 of the second WebRTC client 22 of FIG. 1. Some embodiments may provide that the WebRTC data channel 54 is affiliated with the WebRTC media channel 32 by virtue of being established via the same peer connection 38, and/or by being established using a same cryptographic keying material (not shown).

The WebRTC functionality modification agent 14 of the second WebRTC client 22 next determines whether a client control signal 56 originating from the first WebRTC client (18) (i.e., from the WebRTC client control agent 12) has been received by the second WebRTC client 22 via the WebRTC data channel 54 (block 62). If not, processing loops at block 62 to await the client control signal 56. If the WebRTC functionality modification agent 14 determines at decision block 62 that the client control signal 56 was received, the WebRTC functionality modification agent 14 then modifies a functionality associated with the second WebRTC client 22 (block 64). In some embodiments, modifying functionality associated with the second WebRTC client 22 may include causing the second WebRTC client 22 to modify an attribute associated with one or more communicatively coupled device(s) 40, and/or to initiate or modify execution of an application 52 on the second computing device 20.

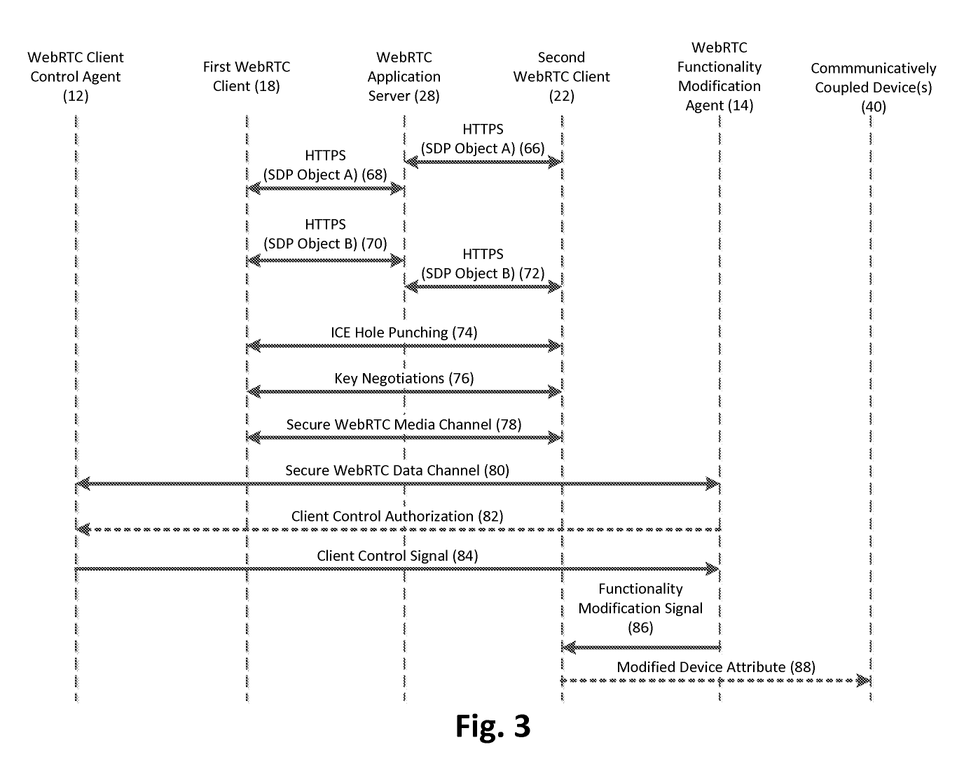

To illustrate exemplary communications flows for remotely controlling the second WebRTC client 22 functionality by the WebRTC client control agent 12 and the WebRTC functionality modification agent 14 of FIG. 1, FIG. 3 is provided. In FIG. 3, the WebRTC client control agent 12, the WebRTC functionality modification agent 14, the first WebRTC client 18, the WebRTC application server 28, the second WebRTC client 22, and the communicatively coupled device(s) 40 of FIG. 1 are each represented by vertical dotted lines. It is to be understood that the first and second WebRTC clients 18, 22 have each downloaded a WebRTC-enabled web application, such as an HTML5/JavaScript WebRTC application, from the WebRTC application server 28.

In the example of FIG. 3, the establishment of a WebRTC interactive flow begins with a WebRTC offer/answer exchange for media negotiations. Accordingly, the second WebRTC client 22 sends a WebRTC session description object to the WebRTC application server 28 in an encrypted format (in this example, via an HTTPS connection). The WebRTC session description object is a Session Description Protocol (SDP) object referred to as SDP Object A, and indicated by arrow 66. SDP Object A represents the “offer” in the WebRTC offer/answer exchange. SDP Object A specifies the media types and capabilities that the second WebRTC client 22 supports and prefers for use in the WebRTC interactive flow. The WebRTC application server 28 forwards the SDP Object A by a secure web connection to the first WebRTC client 18, as indicated by arrow 68.

After the first WebRTC client 18 receives the SDP Object A from the WebRTC application server 28, the first WebRTC client 18 in response sends a WebRTC session description object, referred to as SDP Object B, to the WebRTC application server 28 via a secure network connection, as indicated by arrow 70. The WebRTC application server 28, in turn, forwards the SDP Object B to the second WebRTC client 22, as shown by arrow 72.

With continuing reference to FIG. 3, the first and second WebRTC clients 18, 22 then begin “hole punching” to determine the best way to establish direct communications between the first and second WebRTC clients 18, 22. The hole punching process is indicated by bidirectional arrow 74 in FIG. 3. Hole punching is a technique, often using protocols such as Interactive Connectivity Establishment (ICE), in which two web clients establish a connection with an unrestricted third-party server (not shown) that uncovers external and internal address information for use in direct communications. If the hole punching is successful, the second WebRTC client 22 and the first WebRTC client 18 begin key negotiations to establish a secure peer connection (e.g., the peer connection 38 of FIG. 1) (indicated by bidirectional arrow 76). Upon establishing the secure peer connection, the second WebRTC client 22 and the first WebRTC client 18 establish a WebRTC media channel (e.g., the WebRTC media channel 32 of FIG. 1) over the secure peer connection, as shown by bidirectional arrow 78.

To provide remote control of the second WebRTC client 22 functionality, the WebRTC client control agent 12 of the first WebRTC client 18 establishes a WebRTC data channel (e.g., the WebRTC data channel 54 of FIG. 1) with the WebRTC functionality modification agent 14 of the second WebRTC agent 22, as indicated by bidirectional arrow 80. In some embodiments, the WebRTC client control agent 12 receives a client control authorization from the WebRTC functionality modification agent 14, as indicated by dotted arrow 82. The client control authorization may serve as a confirmation that a user of the second WebRTC client 22 consents to remote control of the second WebRTC client 22 functionality, and may specify limits on the types of functionality that may be remotely modified. In some embodiments, the optional client control authorization may occur as a pre-authorization (i.e., the client control authorization is received prior to the client control signal) as shown, while some embodiments may provide that the client control authorization is received after the client control signal. The client control authorization may authorize a plurality of client control signals, and/or may authorize only a specific corresponding client control signal.

The WebRTC functionality modification agent 14 then receives a client control signal (e.g., the client control signal 56 of FIG. 1) from the WebRTC client control agent 12, as indicated by arrow 84. Based on the client control signal, the WebRTC functionality modification agent 14 may generate a functionality modification signal (represented by arrow 86) to the second WebRTC client 22. The WebRTC functionality modification agent 14 may indicate to the second WebRTC client 22 new functional parameters or instructions based on the received client control signal. In the example of FIG. 3, the second WebRTC client 22 then effects the desired functionality modification by issuing a modified device attribute to the communicatively coupled device(s) 40, as indicated by arrow 88.

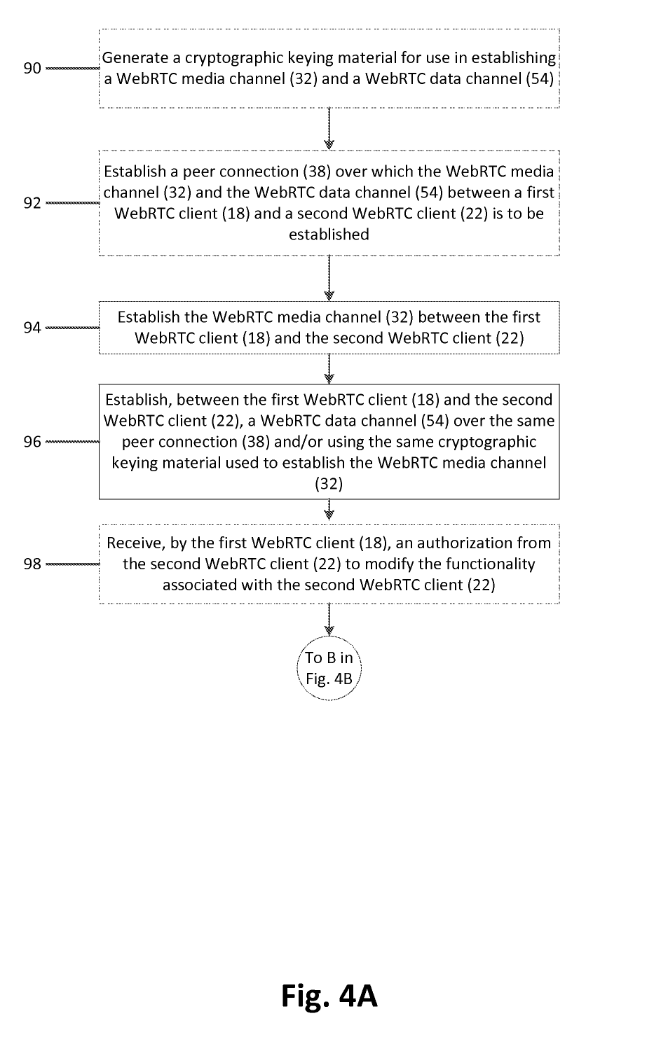

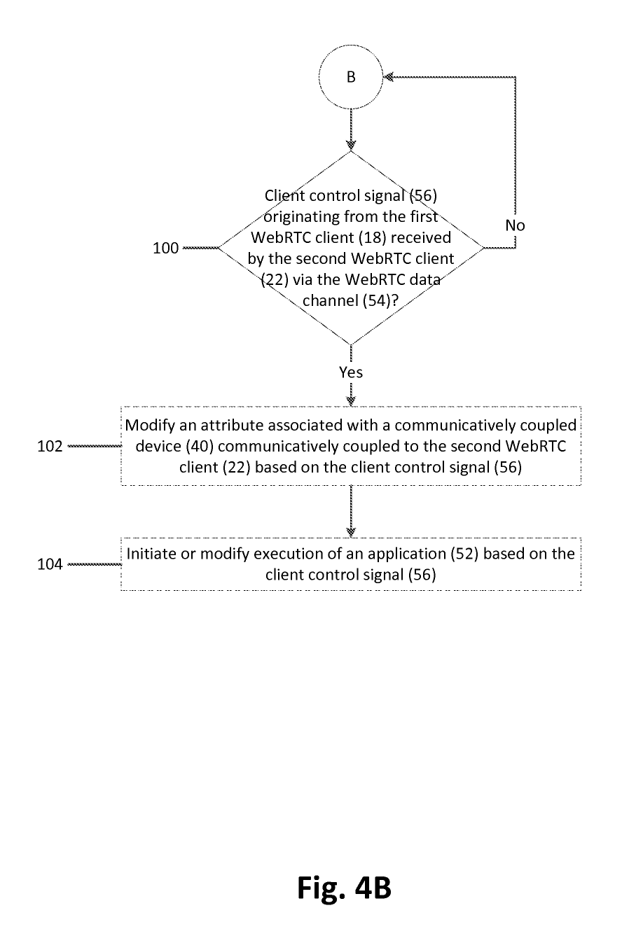

FIGS. 4A and 4B provide in more detail an exemplary generalized process for the WebRTC client control agent 12 and the WebRTC functionality modification agent 14 of FIG. 1 to remotely control WebRTC client functionality. For illustrative purposes, FIGS. 4A and 4B refer to elements of the exemplary WebRTC interactive system 10 of FIG. 1. FIG. 4A illustrates operations for establishing a WebRTC media channel 32 and an affiliated WebRTC data channel 54. FIG. 4B illustrates operations of the WebRTC client control agent 12 and the WebRTC functionality modification agent 14 for providing remote control of WebRTC client functionality.

In FIG. 4A, operations begin with the first WebRTC client 18 and the second WebRTC client 22 optionally generating a cryptographic keying material for use in establishing a WebRTC media channel 32 and a WebRTC data channel 54 (block 90). The first WebRTC client 18 and the second WebRTC client 22 may also establish a peer connection 38 over which the WebRTC media channel 32 and the WebRTC data channel 54 are to be established (block 92). The first WebRTC client 18 and the second WebRTC client 22 then establish the WebRTC media channel 32 (block 94).

The first WebRTC client 18 and the second WebRTC client 22 (in particular, the WebRTC client control agent 12 of the first WebRTC client 18 and the WebRTC functionality modification agent 14 of the second WebRTC client 22) establish a WebRTC data channel 54 over the same peer connection 38 and/or using the same cryptographic keying material used to establish the WebRTC media channel 32 (block 96). Because the WebRTC data channel 54 is established over the same peer connection 38 and/or using the same cryptographic keying material, the WebRTC data channel 54 is “affiliated” with the WebRTC media channel 32.

In some embodiments, the WebRTC client control agent 12 of the first WebRTC client 18 next receives an authorization from the WebRTC functionality modification agent 14 of the second WebRTC client 22 to modify the functionality associated with the second WebRTC client 22 (block 98). The authorization may serve as a confirmation that a user (not shown) of the second WebRTC client 22 consents to remote control of the second WebRTC client 22 functionality, and may specify limits on the types of functionality that may be remotely modified. Processing then resumes at block 100 of FIG. 4B.

Referring now to FIG. 4B, the second WebRTC client 22 (in particular, the WebRTC functionality modification agent 14 of the second WebRTC client 22) determines whether a client control signal 56 originating from the first WebRTC client 18 (i.e., the WebRTC client control agent 12 of the first WebRTC client 18) has been received (block 100). If not, processing loops back to block 100 to await the client control signal 56. If the WebRTC functionality modification agent 14 determines at decision block 100 that the client control signal 56 was received, the WebRTC functionality modification agent 14 may then modify a functionality associated with the second WebRTC client 22. In some embodiments, the WebRTC functionality modification agent 14 may modify an attribute associated with a communicatively coupled device 40 that is communicatively coupled to the second WebRTC client 22 based on the client control signal 56 (block 102). As non-limiting examples, the communicatively coupled device(s) 40 may include an audio input device 42 such as a microphone; an audio output device 44 such as a speaker; a video input device 46 such as a video camera, webcam, or still camera; a video output device 48 such as a video display, and/or another peripheral device 50 such as a building automation device, a voice synthesizer, an audio alarm, a visual alarm, or a sensor.

Modifying the attribute associated with the communicatively coupled device(s) 40 may include adjusting a speaker volume, a speaker muting, a microphone volume, a microphone muting, a microphone directionality, a microphone sensitivity, an audio equalization profile, a camera directionality, a camera focus, a camera zoom, a camera sensitivity, a camera aperture, a camera F-stop, a display resolution, a display brightness, or a display color profile. Some embodiments may provide that the WebRTC functionality modification agent 14 may initiate or modify the execution of an application 52 based on the client control signal 56 (block 104). It is to be understood that the operations of blocks 102 and 104 may occur in any order, and that either of blocks 102 and 104 may be omitted.

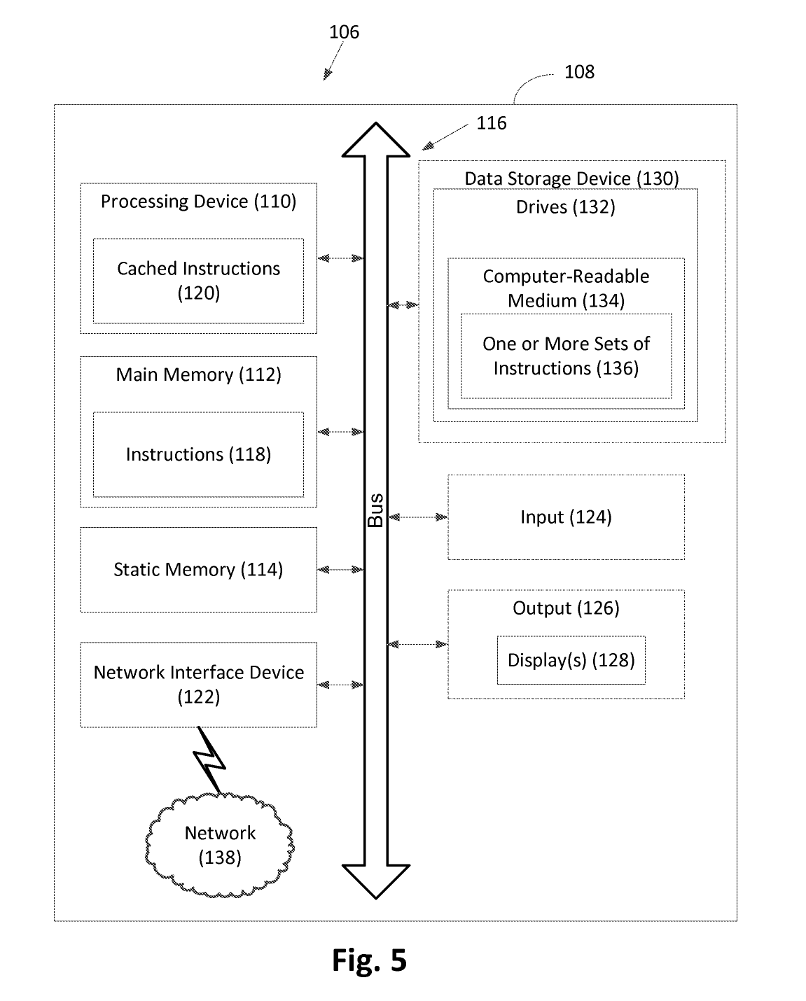

FIG. 5 provides a schematic diagram representation of a processing system 106 in the exemplary form of an exemplary computer system 108 adapted to execute instructions to perform the functions described herein. In some embodiments, the processing system 106 may execute instructions to perform the functions of the first and second WebRTC clients 18, 22, the WebRTC client control agent 12, and the WebRTC functionality modification agent 14 of FIG. 1. In this regard, the processing system 106 may comprise the computer system 108, within which a set of instructions for causing the processing system 106 to perform any one or more of the methodologies discussed herein may be executed. The processing system 106 may be connected (as a non-limiting example, networked) to other machines in a local area network (LAN), an intranet, an extranet, or the Internet. The processing system 106 may operate in a client-server network environment, or as a peer machine in a peer-to-peer (or distributed) network environment. While only a single processing system 106 is illustrated, the terms “controller” and “server” shall also be taken to include any collection of machines that individually or jointly execute a set (or multiple sets) of instructions to perform any one or more of the methodologies discussed herein. The processing system 106 may be a server, a personal computer, a desktop computer, a laptop computer, a personal digital assistant (PDA), a computing pad, a mobile device, or any other device and may represent, as non-limiting examples, a server or a user's computer.

The exemplary computer system 108 includes a processing device or processor 110, a main memory 112 (as non-limiting examples, read-only memory (ROM), flash memory, dynamic random access memory (DRAM) such as synchronous DRAM (SDRAM), etc.), and a static memory 114 (as non-limiting examples, flash memory, static random access memory (SRAM), etc.), which may communicate with each other via a bus 116. Alternatively, the processing device 110 may be connected to the main memory 112 and/or the static memory 114 directly or via some other connectivity means.

The processing device 110 represents one or more processing devices such as a microprocessor, central processing unit (CPU), or the like. More particularly, the processing device 110 may be a complex instruction set computing (CISC) microprocessor, a reduced instruction set computing (RISC) microprocessor, a very long instruction word (VLIW) microprocessor, a processor implementing other instruction sets, or processors implementing a combination of instruction sets. The processing device 110 is configured to execute processing logic in instructions 118 and/or cached instructions 120 for performing the operations and steps discussed herein.

The computer system 108 may further include a communications interface in the form of a network interface device 122. It also may or may not include an input 124 to receive input and selections to be communicated to the computer system 108 when executing the instructions 118, 120. It also may or may not include an output 126, including but not limited to display(s) 128. The display(s) 128 may be a video display unit (as non-limiting examples, a liquid crystal display (LCD) or a cathode ray tube (CRT)), an alphanumeric input device (as a non-limiting example, a keyboard), a cursor control device (as a non-limiting example, a mouse), and/or a touch screen device (as a non-limiting example, a tablet input device or screen).

The computer system 108 may or may not include a data storage device 130 that includes using drive(s) 132 to store the functions described herein in a computer-readable medium 134, on which is stored one or more sets of instructions 136 (e.g., software) embodying any one or more of the methodologies or functions described herein. The functions can include the methods and/or other functions of the processing system 106, a participant user device, and/or a licensing server, as non-limiting examples. The one or more sets of instructions 136 may also reside, completely or at least partially, within the main memory 112 and/or within the processing device 110 during execution thereof by the computer system 108. The main memory 112 and the processing device 110 also constitute machine-accessible storage media. The instructions 118, 120, and/or 136 may further be transmitted or received over a network 138 via the network interface device 122. The network 138 may be an intra-network or an inter-network.

While the computer-readable medium 134 is shown in an exemplary embodiment to be a single medium, the term “machine-accessible storage medium” should be taken to include a single medium or multiple media (as non-limiting examples, a centralized or distributed database, and/or associated caches and servers) that store one or more sets of instructions. The term “machine-accessible storage medium” shall also be taken to include any medium that is capable of storing, encoding, or carrying a set of instructions for execution by the machine, and that cause the machine to perform any one or more of the methodologies disclosed herein. The term “machine-accessible storage medium” shall accordingly be taken to include, but not be limited to, solid-state memories, optical and magnetic media, and carrier wave signals.

The embodiments disclosed herein may be embodied in hardware and in instructions that are stored in hardware, and may reside, as non-limiting examples, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer readable medium known in the art. An exemplary storage medium is coupled to the processor such that the processor can read information from, and write information to, the storage medium. In the alternative, the storage medium may be integral to the processor. The processor and the storage medium may reside in an Application Specific Integrated Circuit (ASIC). The ASIC may reside in a remote station. In the alternative, the processor and the storage medium may reside as discrete components in a remote station, base station, or server.

It is also noted that the operational steps described in any of the exemplary embodiments herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary embodiments may be combined. It is to be understood that the operational steps illustrated in the flow chart diagrams may be subject to numerous different modifications as will be readily apparent to one of skill in the art. Those of skill in the art would also understand that information and signals may be represented using any of a variety of different technologies and techniques. As non-limiting examples, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but is to be accorded the widest scope consistent with the principles and novel features disclosed herein.

What is claimed is:

1. A method for remotely controlling Web Real-Time Communications (WebRTC) client functionality, comprising:
establishing, by a first WebRTC client executing on a first computing device and a second WebRTC client executing on a second computing device, a WebRTC media channel between the first WebRTC client and the second WebRTC client;
establishing, between the first WebRTC client and the second WebRTC client, a WebRTC data channel affiliated with the WebRTC media channel;
receiving, by the second WebRTC client, a client control signal originating from the first WebRTC client via the WebRTC data channel; and
responsive to receiving the client control signal via the WebRTC data channel, modifying a functionality associated with the second WebRTC client.

2. The method of claim 1, wherein modifying the functionality associated with the second WebRTC client comprises modifying an attribute associated with a device communicatively coupled to the second WebRTC client based on the client control signal.

3. The method of claim 2, wherein the device communicatively coupled to the second WebRTC client comprises a device selected from the group consisting of a microphone, a speaker, a video camera, a webcam, a still camera, a video display, a building automation device, a voice synthesizer, an audio alarm, a visual alarm, and a sensor.

4. The method of claim 2, wherein the attribute associated with the device comprises a speaker volume, a speaker muting, a microphone volume, a microphone muting, a microphone directionality, a microphone sensitivity, an audio equalization profile, a camera directionality, a camera focus, a camera zoom, a camera sensitivity, a camera aperture, a camera F-stop, a display resolution, a display brightness, or a display color profile, or combinations thereof.

5. The method of claim 1, wherein modifying the functionality associated with the second WebRTC client comprises initiating or modifying execution of an application on the second computing device based on the client control signal.

6. The method of claim 1, further comprising receiving, by the first WebRTC client, an authorization from the second WebRTC client to modify the functionality associated with the second WebRTC client.

7. The method of claim 1, wherein establishing the WebRTC data channel affiliated with the WebRTC media channel comprises establishing the WebRTC data channel over a same peer connection used in establishing the WebRTC media channel.

8. The method of claim 1, wherein establishing the WebRTC data channel affiliated with the WebRTC media channel comprises establishing the WebRTC data channel using a same cryptographic keying material used in establishing the WebRTC media channel.

9. A system for remotely controlling Web Real-Time Communications (WebRTC) client functionality, comprising:
at least one communications interface;
a first computing device associated with the at least one communications interface and comprising a first WebRTC client, the first WebRTC client comprising a WebRTC client control agent; and
a second computing device associated with the at least one communications interface and comprising a second WebRTC client, the second WebRTC client comprising a WebRTC functionality modification agent;
the first WebRTC client and the second WebRTC client configured to establish a WebRTC media channel between the first WebRTC client and the second WebRTC client; and
the WebRTC client control agent and the WebRTC functionality modification agent configured to establish a WebRTC data channel affiliated with the WebRTC media channel;
the WebRTC functionality modification agent further configured to:
receive a client control signal originating from the WebRTC client control agent via the WebRTC data channel; and
responsive to receiving the client control signal via the WebRTC data channel, modify a functionality associated with the second WebRTC client.

10. The system of claim 9, wherein the WebRTC functionality modification agent is configured to modify the functionality associated with the second WebRTC client by modifying an attribute associated with a device communicatively coupled to the second WebRTC client.

11. The system of claim 10, wherein the WebRTC functionality modification agent is configured to modify the attribute associated with the device selected from the group consisting of a microphone, a speaker, a video camera, a webcam, a still camera, a video display, and a building automation device.

12. The system of claim 10, wherein the WebRTC functionality modification agent is configured to modify the attribute comprising a speaker volume, a speaker muting, a microphone volume, a microphone muting, a microphone directionality, a microphone sensitivity, an audio equalization profile, a camera directionality, a camera focus, a camera zoom, a camera sensitivity, a camera aperture, a camera F-stop, a display resolution, a display brightness, or a display color profile, or combinations thereof.

13. The system of claim 9, wherein the WebRTC functionality modification agent is configured to modify the functionality associated with the second WebRTC client by launching an application on the second computing device.

14. The system of claim 9, wherein the WebRTC client control agent is configured to receive an authorization from the WebRTC functionality modification agent to modify the functionality associated with the second WebRTC client.

15. A non-transitory computer-readable medium having stored thereon computer-executable instructions to cause a processor to implement a method, comprising:
establishing a Web Real-Time Communications (WebRTC) media channel between a first WebRTC client and a second WebRTC client;
establishing, between the first WebRTC client and the second WebRTC client, a WebRTC data channel affiliated with the WebRTC media channel;
receiving, by the second WebRTC client, a client control signal originating from the first WebRTC client via the WebRTC data channel; and
responsive to receiving the client control signal via the WebRTC data channel, modifying a functionality associated with the second WebRTC client.

16. The non-transitory computer-readable medium of claim 15 having stored thereon the computer-executable instructions to cause the processor to implement the method, wherein modifying the functionality associated with the second WebRTC client comprises modifying an attribute associated with a device communicatively coupled to the second WebRTC client.

17. The non-transitory computer-readable medium of claim 16 having stored thereon the computer-executable instructions to cause the processor to implement the method, wherein the device communicatively coupled to the second WebRTC client comprises a device selected from the group consisting of a microphone, a speaker, a video camera, a webcam, a still camera, a video display, and a building automation device.

18. The non-transitory computer-readable medium of claim 17 having stored thereon the computer-executable instructions to cause the processor to implement the method, wherein the attribute associated with the device comprises a speaker volume, a speaker muting, a microphone volume, a microphone muting, a microphone directionality, a microphone sensitivity, an audio equalization profile, a camera directionality, a camera focus, a camera zoom, a camera sensitivity, a camera aperture, a camera F-stop, a display resolution, a display brightness, or a display color profile, or combinations thereof.

19. The non-transitory computer-readable medium of claim 15 having stored thereon the computer-executable instructions to cause the processor to implement the method, wherein modifying the functionality associated with the second WebRTC client comprises launching an application on a computing device executing the second WebRTC client.

20. The non-transitory computer-readable medium of claim 15 having stored thereon the computer-executable instructions to cause the processor to implement the method, further comprising receiving, by the first WebRTC client, an authorization from the second WebRTC client to modify the functionality associated with the second WebRTC client.
